(19) United States
(12) Patent Application Publication
(10) Pub. No.: US 2013/0040624 A1
(43) Pub. Date: Feb. 14, 2013

(54) Systems and Methods for Location Based Call Forwarding

(71) Applicant: John M. Taboada, San Antonio, TX (US)

(72) Inventor: John M. Taboada, San Antonio, TX (US)

(21) Appl. No.: 13/569,295

(22) Filed: Aug. 8, 2012

Related U.S. Application Data
(60) Provisional application No. 61/521,213, filed on Aug. 8, 2011.

(51) Int. Cl. H04W 4/00

(52) U.S. Cl. 455/417

(57) ABSTRACT

Methods and systems for location based call forwarding are disclosed, including determining a location of a first communication device; determining a location of a second communication device; and forwarding a call made to the first communication device to the second communication device if the location of the first communication device and the location of the second communication device are substantially the same.

### I. CROSS REFERENCE TO RELATED APPLICATIONS

This application CLAIMS PRIORITY to U.S. Provisional Application Ser. No. 61/521,213 filed on Aug. 8, 2011, which is incorporated herein by reference in its entirety.

### II. BACKGROUND

The invention relates generally to the field of telephone call forwarding.

### III. SUMMARY

In one respect, disclosed is a method for location based call forwarding, the method comprising: determining a location of a first communication device; determining a location of a second communication device; and forwarding a call made to the first communication device to the second communication device if the location of the first communication device and the location of the second communication device are substantially the same.

In another respect, disclosed is an apparatus for location based call forwarding, the apparatus comprising: one or more processors; one or more memory units coupled to the one or more processors; and a logic controller unit coupled to the one or more processors, the logic controller unit being configured to enable location based call forwarding; the apparatus being configured to: determine a location of a first communication device; determine a location of a second communication device; and forward a call made to the first communication device to the second communication device if the location of the first communication device and the location of the second communication device are substantially the same.

In yet another respect, disclosed is method for location based call forwarding, the method comprising: determining a location of a first communication device; determining a location of a second communication device; and forwarding a call made to a forwarding number to the first communication device and to the second communication device if the location of the first communication device and the location of the second communication device are substantially the same.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a block diagram illustrating a system for location based call forwarding, in accordance with some embodiments.

FIG. 2 is a flow diagram illustrating a method for location based call forwarding, in accordance with some embodiments.

FIG. 3 is a flow diagram illustrating a method for location based call forwarding, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

There are services available that allow a user to have a single phone number capable of being forwarded to one or more communication devices, a so called forwarding number. Google Voice is one such service that allows a user's Google Voice Number (GVN) to be forwarded to up to six other phones. For example, if the user has their GVN enabled to be forwarded to their home landline phone, work phone, or mobile phone, then when someone calls the user's GVN, all three communication devices will ring. This allows the user to pick up any of the three communication devices in order to answer the call. This is very helpful since the user's mobile phone sometimes does not ring due to difficulties in mobile communication, but the call could still be answered using one of the other enabled communication devices, such as the landlines or even other mobile or computing devices.

An advantage of being able to answer on multiple devices is that the user can elect to answer on the device that is the most convenient. For example, allowing a user to answer a call on the landline allows the user to conserve the battery of the mobile device, thus preserving the life of the battery for when mobile communication is required or desired.

A user for example may have their GVN forwarded to their mobile phone at all times and would only desire to have their GVN forward to other communication devices only if the other communication devices were accessible to the user. For example, a situation may exist where the user is in or close to their office and they would desire to have their office phone ring when a call is placed to their GVN. Similarly for the case with the home phone when the user is at home. Currently, the user can enable to have their GVN forwarded to these additional phones, but it has to be done manually, i.e. the user has to login to their account and select which communication devices their GVN should be forwarded to. What is needed is a system and apparatus that would allow the user to automatically have the calls forwarded to the additional communication devices if these additional communication devices were accessible to the user.

Most often, a user's mobile device such as a smart phone is in close proximity to the user, either on a counter or in a pocket, purse, or briefcase. Thus, the location of the smart phone may be used to locate the user, either at home or at the office for example. In some embodiments, the location of a smart phone can be determined in a number of different ways such as with GPS signals technology, assisted GPS technology, and router location lookup tables. For a landline phone, a lookup table of the location of the landline phone may be generated in order to know its location. A smart phone may have a GPS chip integrated within it which is capable of determining its location using the GPS satellites. It can also use the GPS signals in combination with the mobile phone tower network in determining the location of the smart phone. This location determination is referred to as assisted GPS technology. If the smart phone has integrated Wi-Fi and is within range of a router whose location has been mapped and recorded, the location of the smart phone may also be determined. The next step would be to determine if the smart phone is substantially in the same location as one of the other communication devices. If it is, then if a call is placed to the user's GVN, the other communication device will ring in addition to the user's smart phone. This location based call forwarding can either be automatically integrated into the service such as Google Voice or the user may have the option to enable location based call forwarding. Giving the user the option to enable location based call forwarding would still allow the user the option to ring any of the selected communication devices even if their smart phone is not in the same location as the other communication devices, i.e. non-location based call forwarding.

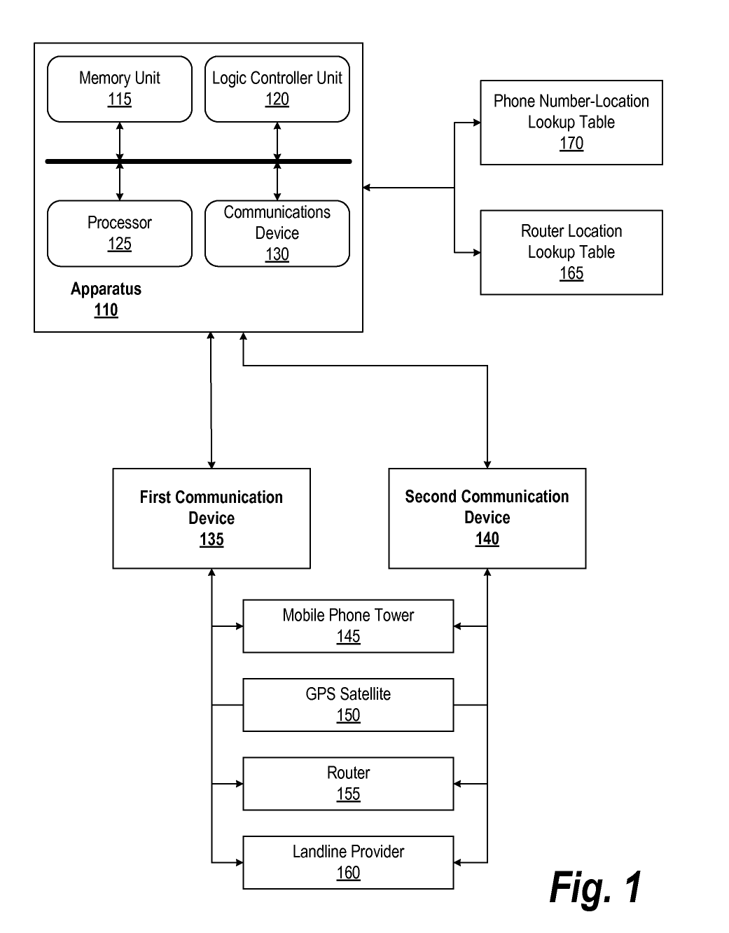

FIG. 1 is a block diagram illustrating a system for location based call forwarding, in accordance with some embodiments.

In some embodiments, apparatus 110 comprises processor 125, memory unit 115, logic control unit 120, and communications device 130, all of which are directly or indirectly coupled to each other. The processor 125 and the memory unit 115 provide the computing backbone for the logic controller unit 120 and communications device 130. The apparatus is capable of communicating with one or more communication devices. In this embodiment, there is a first communication device 135 and a second communication device 140. The communication devices may be in contact with a mobile phone tower 145, a GPS satellite 150, a router 155, or landline provider 160. If the communication device is a smart phone, it is possible to be in contact with a mobile phone tower, a GPS satellite, or a router. If the communication device is a landline phone, it is in contact with the landline provider. If the communication device is a Voice over Internet Protocol (VOIP) device, it will be in contact through a router. The apparatus takes input from either the user or as a default setting, to set the logic controller unit 120 to either forward calls based on location or not. If location based call forwarding is enabled, then when a call is placed to the first communication device, the apparatus checks to see if other communication devices are in the vicinity of the first communication device. If they are and if location based call forwarding is enabled, then the apparatus will also forward the call to these other communication devices. In determining the location, the apparatus may consult a router location lookup table 165 if the communication device is in contact with a router 155. Similarly, the apparatus may determine the location of the device from the phone number of the device and reference to a phone number-location lookup table. This could be the case for a traditional landline phone. In some embodiments, the apparatus is integrated into the communication device.

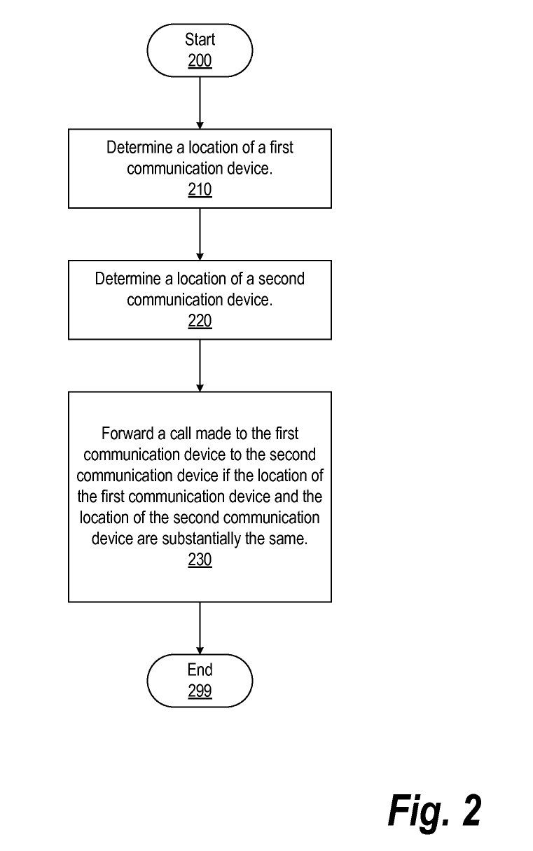

FIG. 2 is a flow diagram illustrating a method for location based call forwarding, in accordance with some embodiments.

In some embodiments, the method illustrated in FIG. 2 may be performed by one or more of the devices illustrated in FIG. 1. Processing begins at 200 whereupon, at block 210, the location of a first communication device is determined. At block 220, the location of a second communication device is determined. Then, at block 230, if a call is placed to the first communication device, the call will be forwarded to the second communication device if the location of the first communication device and the location of the second communication device are substantially the same. Alternatively, if a forwarding number is used and a call is made to the forwarding number, the call will be forwarded to the first communication device and to the second communication device if the location of the first communication device and the location of the second communication device are substantially the same. Processing subsequently ends at 299.

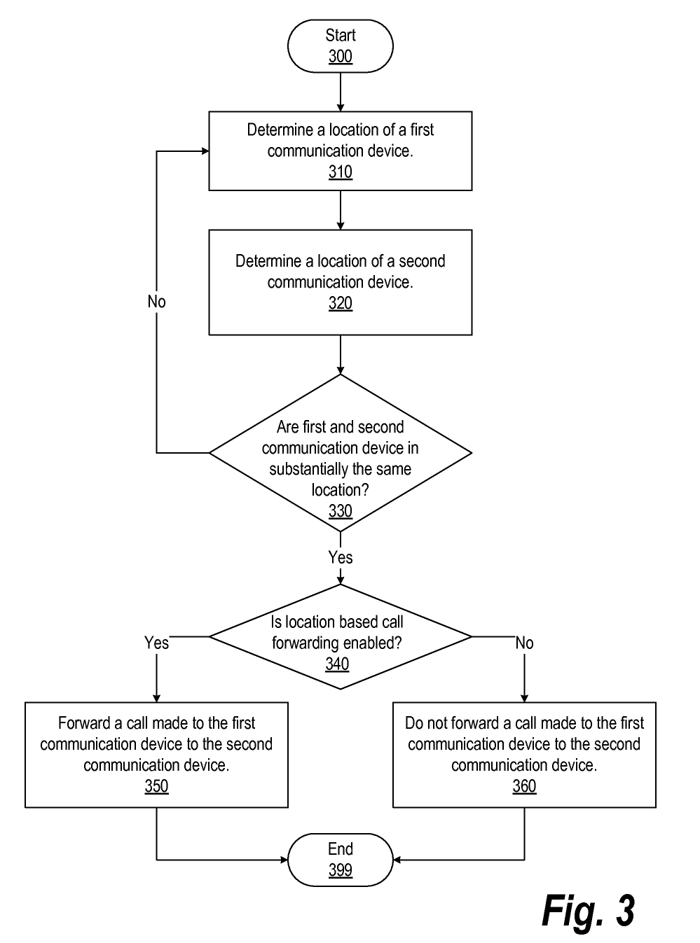

FIG. 3 is a flow diagram illustrating a method for location based call forwarding, in accordance with some embodiments.

In some embodiments, the method illustrated in FIG. 3 may be performed by one or more of the devices illustrated in FIG. 1. Processing begins at 300 whereupon, at block 310, the location of a first communication device is determined. At block 320, the location of a second communication device is determined. At decision block 330, a check is made to see if the first and second communication devices are in substantially the same location. If they are not, the processing loops back to block 310. If the communication devices are in substantially the same location, processing continues to decision block 340 to check to see if location based call forwarding is enabled. If it is, at block 350 calls made to the first communication device are forwarded to the second communication device. If the devices are not in the same location, processing continues to block 360 where calls made to the first communication device are not forwarded to the second communication device. Processing subsequently ends at 399.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for location based call forwarding, the method comprising:
determining a location of a first communication device;
determining a location of a second communication device; and
forwarding a call made to the first communication device to the second communication device if the location of the first communication device and the location of the second communication device are substantially the same.

2. The method of claim 1, where determining the location of the first communication device comprises at least one of: using GPS signals technology, using assisted GPS technology, using a router location lookup table, and using a phone number-location lookup table.

3. The method of claim 1, where determining the location of the second communication device comprises at least one of: using GPS signals technology, using assisted GPS technology, using a router location lookup table, and using a phone number-location lookup table.

4. The method of claim 1, wherein the first communication device comprises a mobile phone.

5. The method of claim 1, wherein the first communication device comprises a smart phone.

6. The method of claim 1, wherein the first communication device comprises a computing device.

7. The method of claim 1, wherein the second communication device comprises a landline phone.

8. The method of claim 1, wherein the second communication device comprises a VOIP phone.

9. The method of claim 1, wherein the call comprises at least one of: voice data, image data, and text data.

10. An apparatus for location based call forwarding, the apparatus comprising:
one or more processors;
one or more memory units coupled to the one or more processors; and
a logic controller unit coupled to the one or more processors, the logic controller unit being configured to enable location based call forwarding;
the apparatus being configured to:
determine a location of a first communication device;
determine a location of a second communication device; and
forward a call made to the first communication device to the second communication device if the location of the first communication device and the location of the second communication device are substantially the same.

11. The apparatus of claim 10, where the apparatus being configured to determine the location of the first communication device comprises at least one of: using GPS signals technology, using assisted GPS technology, using a router location lookup table, and using a phone number-location lookup table.

12. The apparatus of claim 10, where the apparatus being configured to determine the location of the second communication device comprises at least one of: using GPS signals technology, using assisted GPS technology, using a router location lookup table, and using a phone number-location lookup table.

13. The apparatus of claim 10, wherein the first communication device comprises a mobile phone.

14. The apparatus of claim 10, wherein the first communication device comprises a smart phone.

15. The apparatus of claim 10, wherein the first communication device comprises a computing device.

16. The apparatus of claim 10, wherein the second communication device comprises a landline phone.

17. The apparatus of claim 10, wherein the second communication device comprises a landline phone.

18. The apparatus of claim 10, wherein the call comprises at least one of: voice data, image data, and text data.

19. A method for location based call forwarding, the method comprising:
determining a location of a first communication device;
determining a location of a second communication device; and
forwarding a call made to a forwarding number to the first communication device and to the second communication device if the location of the first communication device and the location of the second communication device are substantially the same.

20. The method of claim 19, where determining the location of the first and second communication devices comprises at least one of: using GPS signals technology, using assisted GPS technology, using a router location lookup table, and using a phone number-location lookup table.
